(19) United States
(12) Patent Application Publication
(10) Pub. No.: US 2004/0205757 A1
(43) Pub. Date: Oct. 14, 2004

(54) Performance scheduling using multiple constraints

(76) Inventor: Trevor A. Pering, Mountain View, CA (US)

Correspondence Address: INTEL CORPORATION, P.O. BOX 5326, SANTA CLARA, CA, 95056-5326, US

(21) Appl. No.: 10/411,818

(22) Filed: Apr. 9, 2003

(51) Int. Cl. G06F 9/00

(52) U.S. Cl. 718/102

(57) ABSTRACT

Processor speed associated with each of different types of processing requirements is determined. These processor speeds are aggregated together to form an effective processor speed for a processor in a system. The processor speed for the processor enables meeting the different types of processing requirements while reducing power consumption.

### FIELD OF THE INVENTION

The present invention relates to computing systems, and in particular, to power consumption of the computing systems.

### BACKGROUND OF THE INVENTION

Computer systems are pervasive in the world, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers.

Over the last few years, there have been many advances in semiconductor technology that have resulted in the development of improved electronic devices having integrated circuits (IC) operating at higher frequencies and supporting additional and/or enhanced features. While these advances have enabled hardware manufacturers to design and build faster and more sophisticated computer systems, they have also imposed a disadvantage in higher power consumption, especially for battery-powered computer systems.

A variety of techniques are known for reducing the power consumption in computer systems. For example, the Advanced Configuration and Power Interface (ACPI) Specification (Rev. 2.0b, Oct. 11, 2002) sets forth information about how to reduce the dynamic power consumption of portable and other computer systems. With respect to processors used in computer systems, four processor power consumption modes (C0, C1, C2, and C3) are defined in the ACPI Specification. For example, when the processor is executing instructions, it is in the C0 mode. The C0 mode is a high power consumption mode. When the processor is not executing instructions or idle, it may be placed in one of the low power consumption modes C1, C2 or C3. An Operating System (OS) in the computer system may dynamically transition the idle processor into the appropriate low power consumption mode.

The C1 power mode is the processor power mode with the lowest latency. The C2 power mode offers improved power savings over the C1 power mode. In the C2 power mode, the processor is still able to maintain the context of the system caches. The C3 power mode offers still lower power consumption compared to the C1 and C2 power modes, but has higher exit latency than the C2 and C1 power modes. In the C3 power mode, the processor may not be able to maintain coherency of the processor caches with respect to other system activities.

While the reduced power consumption modes defined by the ACPI Specification and known techniques have some advantages, there is a continuing need for improvement over the current techniques.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 is a block diagram that illustrates an example of a prior art computer system.

FIG. 2 is a block diagram that illustrates an example of a scheduler that may consider multiple types of processing requirements, according to one embodiment.

FIGS. 3A, 3B, and 3C illustrate block diagram examples of different processing requirements, according to one embodiment.

FIG. 4 is a block diagram illustrating an example of aggregating the processor speeds associated with the different processing requirements, according to one embodiment.

FIG. 5 is a block diagram illustrating an example of arranging tasks based on their processing requirements, according to one embodiment.

FIG. 6 is a flow diagram illustrating an example of a process used to determine a performance profile, according to one embodiment.

FIG. 7 is a flow diagram illustrating an example of a process used to determine an aggregate processor speed, according to one embodiment.

### DETAILED DESCRIPTION

For one embodiment, methods and apparatus for establishing a performance profile for a computer system are disclosed. The performance profile may be established using two or more different types of processing requirements or constraints of two or more tasks. The performance profile may help meet the processing requirements while reducing power consumption.

In the following description, for purposes of explanation, numerous specific details are set forth in order to provide a thorough understanding of the present invention. It will be evident, however, to one skilled in the art that the present invention may be practiced without these specific details. In other instances, well-known structures, processes and devices are presented in terms of block diagrams and flowcharts to illustrate embodiments of the invention, and they may not be discussed in detail to avoid unnecessarily obscuring the understanding of this description.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

### Single Type of Processing Requirement

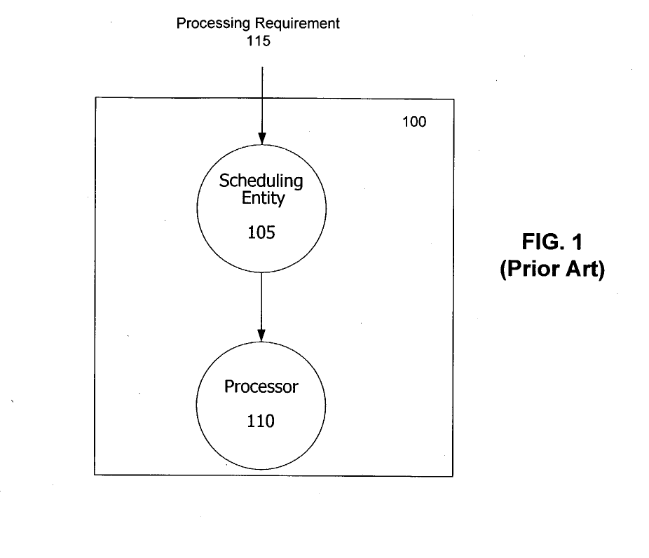

FIG. 1 is a block diagram that illustrates an example of a prior art computer system. Typically, computer system 100 may include a scheduler 105 (e.g., a voltage scheduler). The computer system 100 may also include processor 110. When the processor 110 is set to run at a highest possible processor speed (e.g., as specified by the processor manufacturer), the power consumption of the processor 110 may be high. The power consumption of the processor 110 may be controlled by adjusting the processor speed of the processor 110 using techniques available today. One technique, for example, is dynamic voltage management (DVM). Using DVM, the performance and the power consumption of the processor 110 may be adjusted by the scheduler 105. The adjustment may be performed at run-time. For example, when the processor 110 is not busy, processor frequency and voltage may be reduced. By operating at a processor speed that is less than the highest processor speed, the power consumption of the processor 110 may be reduced.

There may be some costs associated with operating the processor 110 at less than its highest possible processor speed. When the processor speed is slower than desired by an application, the application may fail. When the processor speed is faster than desired by the application, unnecessary power consumption may occur. For example, in a media play-back application, the application may require the processor 110 to run at a high processor speed to enable better user experience. The application may be active for a short period of time, and it may remain inactive for a long period of time. When using DVM, the processor speed may be reduced when the application is inactive. However, this reduced processor speed may be too slow when the application becomes active.

Different techniques are available to help better determine a processor speed for the processor 110. However, these techniques consider only a single type of processing requirement, as illustrated in FIG. 1. Because only a single type of processing requirement is considered to determine the processor speed, the processor speed may be optimal for one type of processing requirement and may not be optimal for another type of processing requirement.

Determining an optimal processor speed when considering all of the different types of processing requirements may be difficult, especially when such processor speed is not to substantially interfere with, for example, the user experience or the reliability of the application. Various predictive scheduling techniques have been proposed. These scheduling techniques include, for example, assigning a frequency or predetermined supply voltage to each operation in a data flow graph of an application so as to minimize the average energy consumption for given computation time or throughput constraints or both. Alternatively, self-timed circuits that lower the supply voltage until the processor meets the processing requirement have been proposed. This approach scales supply voltage dynamically according to the quantity of processing data per unit time. Unfortunately, predictive methods and self-timing circuits often provide suboptimal performance when applied to multimedia applications such as video or audio processing. To be useful, the prediction algorithms or timing circuitry need to accurately predict future computational needs based on content data (e.g., contents of a MPEG frame). Even if the prediction is accurate, such an approach may require substantial extra processing (and therefore more energy and power consumption) in order to generate the prediction.

### Multiple Types of Processing Requirements

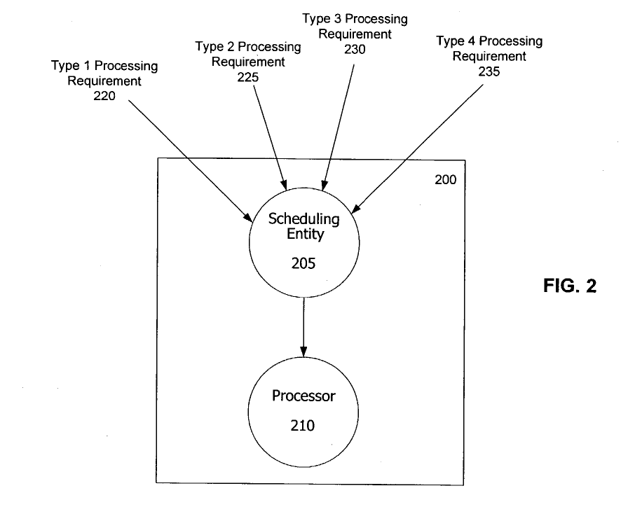

FIG. 2 is a block diagram that illustrates an example of a scheduler that may consider multiple types of processing requirements, according to one embodiment. In this example, the computer system 200 may include scheduler 205 (e.g., a voltage scheduler). The computer system 200 may also include many different entities. For example, these entities may be hardware, firmware, operating system (OS), high-level applications, etc. Each entity may require processing resources from the processor 210. Each entity may have a different processing requirement. The processing requirements may be of the same type or they may be of different types. For example, referring to FIG. 2, the different types of processing requirements may include processor utilization (or type 1) 220, deadline-based (or type 2) 225, buffer-level (or type 3) 230, and rate-based (or type 4) 235. Although not described here, embodiments of the invention may also include other types of processing requirements in addition to the processing requirements 220-235.

For one embodiment, the scheduler 205 may use the different types of processing requirements 220-235 together to form a performance profile. The scheduler 205 may need to understand the different types of processing requirements and have a mechanism for combining or blending them into one combined processing requirement. For example, the scheduler 205 may need to be able to reconcile the processing requirements associated with the buffer-level processing requirement, rate-based processing requirement, utilization processing requirement, and deadline-based technique into one aggregate. The performance profile may affect how the different types of processing requirements may be met, and how much processing resources may be allocated. For one embodiment, the performance profile may include information that may enable performance tuning. For example, depending on the processing requirements, the performance profile may include information about one or more of communication bandwidth, memory bus speed, memory bus width, processor speed, etc.

### Processor Speed Associated with Processing Requirement

For one embodiment, each processing requirement may be associated with a desired processor speed. The desired processor speed may be specified by the entity (e.g., hardware, firmware, OS, application software, etc). The desired processor speed may also be specified by a source external to the entity (e.g., by a user or by another application).

For one embodiment, the processor utilization processing requirement may relate to the utilization of the processor 210 in a given time window. For example, depending on how much the processor 210 is utilized (e.g., busy or idle), the processor speed may be reduced or increased.

For one embodiment, the deadline-based processing requirement may relate to the completion of a predicted amount of work by a deadline. For example, the desired processor speed for the processor 210 may be approximated using the following equation:

Processor speed=amount of work/length of time allowed to complete work.

For example, in the media play-back application, a frame rate (which may be translated to a periodic rate and frame deadline) and cycles-per-frame (either for each frame or for all frames) that need to be completed by a given time period are specified and used to approximate the required processor speed. However, when the frame rate is not met within the given time period (or deadline), the scheduler 205 (e.g., voltage scheduler) may increase the processor speed of the processor 210. This may help meet the deadline-based processing requirement within the given time period. The deadline-based processing requirement may be used for time critical applications.

For one embodiment, the buffer-level processing requirement may relate to one or more of input and output buffer levels used by a particular entity. For example, in a video decoder application, when the output buffer is full with output video frames, the processor speed of the processor 210 may be reduced (and the application may run slower) because there is no short term need for more output video frames. As another example, in an encrypted file-copy application where the rate-limiting factor is a communication channel, the processor speed of the processor 210 may be dictated by how full a communication buffer is. In transmitting data from the buffer, when the buffer is full, the processor may run at a slow processor speed. When the buffer is empty, the processor may run at a faster processor speed. The buffer-level processing requirement may also be used for time critical applications.

For one embodiment, the rate-based processing requirement may relate to getting a sustained rate of processing, independent of any other processing requirements such as, for example, deadline, buffer-level, or processor utilization. For example, a compilation entity (or application) may specify that it needs a certain “cycles per second” average (e.g., 200 MHz-equivalent processor speed) even through the processor 210 may be capable of running a much higher processor speed. There may be no inherent deadline processing requirement associated with the compilation entity, but a steady rate of progress processing requirement may be desired. This information may be useful to allow the computer system 200 to allocate enough processing resources for the compilation entity to make progress and avoid resource starvation without having to push the processor 210 to a rate that may cause unnecessary power consumption. The rate-based processing requirement may be used for non-time critical applications.

It may be noted that many entities in the computer system 200 may have “unidentified” or no processing requirements. For one embodiment, when no processing requirement is provided, the scheduler 205 may need to use a default processing requirement. For example, the scheduler 205 may assume that the entity is a low-computation entity having a processing requirement that is short in duration and low in processor utilization. As a result, the scheduler 205 may set the processor speed of the processor 210 to run at a slow speed.

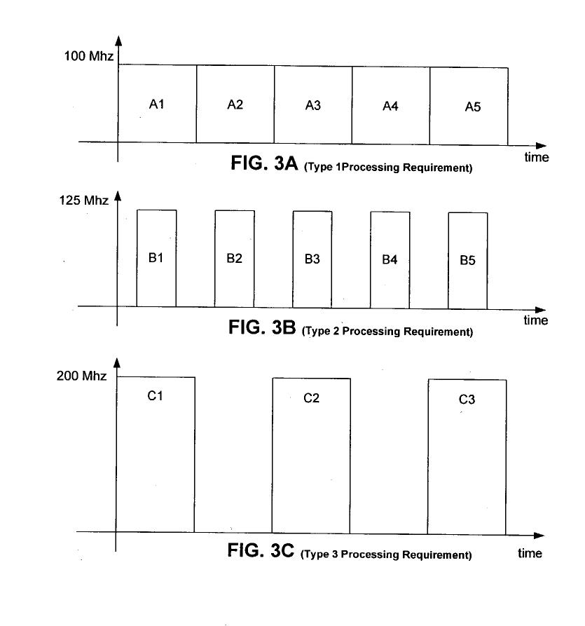

FIGS. 3A, 3B, and 3C illustrate block diagram examples of different processing requirements, according to one embodiment. As described above, each processing requirement received by the computer system 200 may be associated with a processor speed. As an example, the computer system 200 may be handling three different tasks (or applications). Each task may have a different type of processing requirement. As illustrated in the diagram example in FIG. 3A, the first task (“A”) may have a first type of processing requirement which may be associated with a desired processor speed (speed “A”) at 100 MHz. In this example, the first task (“A”) may include sub-tasks A1-A5. The first processing requirement may be a rate-based processing requirement, and it may need a sustained processor speed of 100 MHz. As illustrated in the diagram example in FIG. 3B, the second task (“B”) may have a second type of processing requirement which may be associated with a desired processor speed (speed “B”) at 125 MHz. In this example, the second task (“B”) may include sub-tasks B1-B5. The second processing requirement may be a deadline-based processing requirement. As long as all of the sub-tasks B1-B5 are completed by the deadline, the processing requirement of the task “B” is considered to be met.

As illustrated in the diagram example in FIG. 3C, the third task (“C”) may have a third type of processing requirement which may be associated with a desired processor speed (speed “C”) at 200 MHz. In this example, the third task (“C”) may include sub-tasks C1-C3. The third processing requirement may be a buffer-level processing requirement. The processing requirement for the third task “C” may desire a processor speed at 200 MHz for a period long enough to fill the buffer (sub-task C1) but may not need much processor speed until the buffer needs to be filled again (sub-task C2).

### Aggregating Processor Speeds

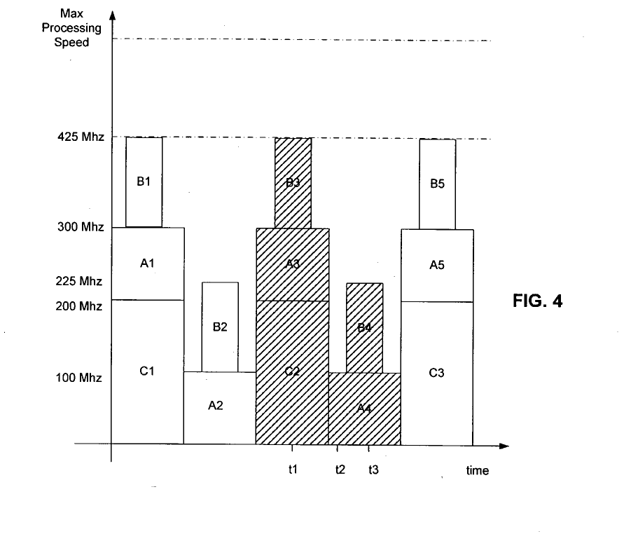

For one embodiment, the processor speeds associated with the different processing requirements may be used to form the performance profile, including forming an effective processor speed to meet all of the different types of processing requirements. For one embodiment, this includes aggregating the processor speeds associated with each of the different processing requirements and forming the effective processor speed for the processor 210. FIG. 4 is a block diagram illustrating an example of aggregating the processor speeds associated with the different processing requirements, according to one embodiment. For one embodiment, the processor speeds associated with the processing requirements of the tasks “A”, “B”, and “C” may be added together to yield an overall processor speed estimate of:

Processor Speed=“Speed A”+“Speed B”+“Speed C”.

Referring to FIG. 4, the aggregated effective processor speed is illustrated as approximately 425 MHz (100+125+200). Thus, in this example, when the processor 210 is set to run at an effective speed of 425 MHz, the processing requirements of the tasks “A”, “B”, and “C” may be met. Furthermore, these processing requirements may be met without having to set the processor 210 to run at its highest possible processor speed. This may help reduce any unnecessary power consumption.

It may be noted that other techniques may also be used to combine the processor speeds associated with the different types of processing requirements to form an effective processor speed. For example, an algorithm may be employed to consider cross-algorithm effects between the different types of processing requirements. Furthermore, although the techniques described refer to determining an effective processor speed, one skilled in the art may recognize that other performance related factors may also be determined. For example, it may be possible to consider the multiple types of processing requirements to determine thermal property, cooling property, etc. of the computer system 200.

Referring to the example illustrated in FIG. 4, the aggregate effective processor speed of 425 MHz may be more than necessary at certain times. For example, at time t1, the processor speed may be sufficient to meet all of the processing requirements of the tasks “A”, “B”, and “C”. However, at times t2 and t3, the processor speed may be more than necessary and may result in unnecessary power consumption.

### Arranging Workloads Based on Processing Requirements

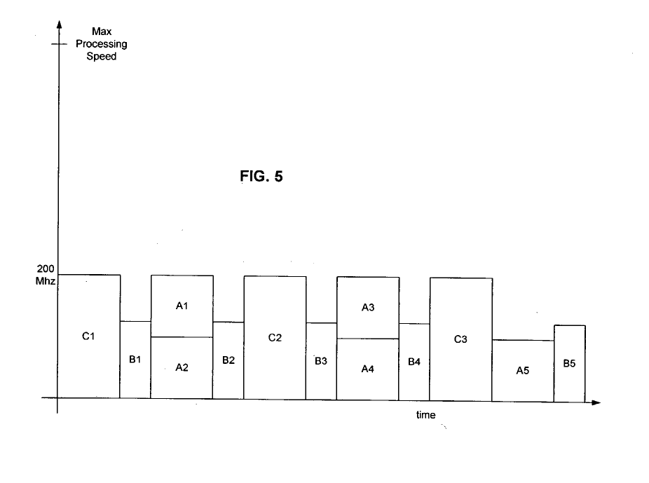

FIG. 5 is a block diagram illustrating an example of arranging tasks based on their processing requirements, according to one embodiment. In the example illustrated in FIG. 3, it may not matter how much processing resources are allocated to the deadline processing requirement of the task “B” as long as the deadline is met. Thus, it may not be advantageous to meet the processing requirement of the task “B” any earlier than its deadline.

For one embodiment, to further reduce power consumption while meeting the different processing requirements, the aggregated processor speed (in this example, at 425 MHz) may be lowered as long as all of the processing requirements of all the tasks are met. As the processor speed is reduced, it may take longer to meet the some of the processing requirements, but the power consumption of the computer system 200 may be reduced. As illustrated in FIG. 5, it may take the computer system 200 longer to meet one or more of the processing requirements of the tasks “A”, “B”, and “C”, but the processing requirements of these tasks may be met at the reduced processor speed. In this example, the processor speed may be reduced from 425 MHz to 200 MHz. Note that in the diagram of FIG. 5, the blocks become longer, but less tall, and the area of each block is conserved (as compared to those in FIG. 4).

### Aggregating Process

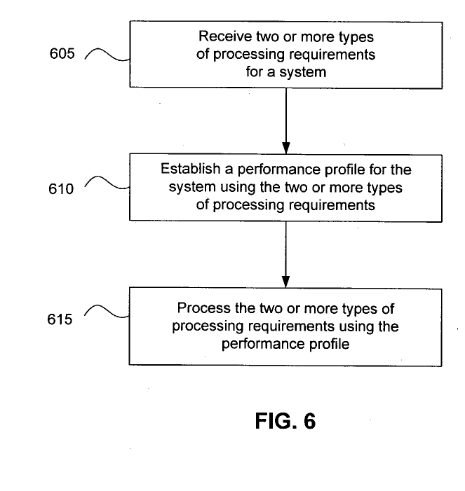

FIG. 6 is a flow diagram illustrating an example of a process used to determine a performance profile, according to one embodiment. At block 605, two or more processing requirements are received. The processing requirements may have different types. For example, some may be rate-based while others may be deadline-based. At block 610, the processing requirements are used to form a performance profile. As described above, this may include determining a processor speed associated with each processing requirement. At block 615, the performance profile is used by the computer system 200 to meet the processing requirements. This may include, for example, setting the processor speed, communication bandwidth, memory bus, etc. to handle the processing requirements.

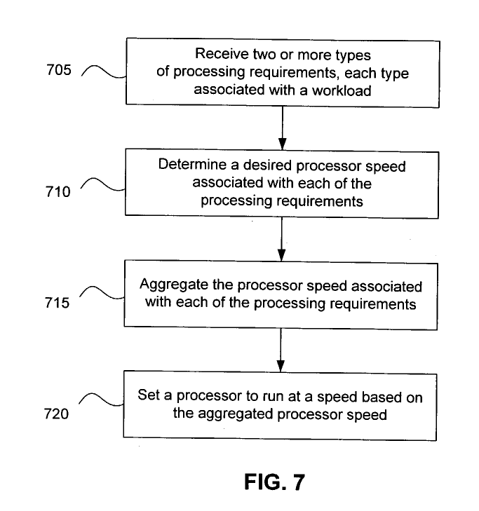

FIG. 7 is a flow diagram illustrating an example of a process used to determine an aggregate processor speed, according to one embodiment. At block 705, two or more processing requirements are received. The processing requirements may have different types. Each processing requirement may be associated with an entity or a task (e.g., an application). At block 710, a desired processor speed associated with each processing requirement is determined. As described above, the desired processor speed may be specified by the entity or it may be determined for the entity by, for example, a source external to the entity.

At block 715, the individual desired processor speeds are aggregated to form an effective processor speed for the processor 200. At block 720, the processor 200 is set to run at the effective processor speed. The process in FIG. 7 is illustrated in the block diagram example of FIG. 4. It may be noted that the process may be further enhanced by arranging the tasks such that their processing requirements are met even at a lower processor speed. This is illustrated in the block diagram example of FIG. 5.

One advantage of the techniques described is that they enable a computer system to accommodate different processing requirements from different tasks (or entities) instead of accommodating with just one processing requirement at the expense of the other processing requirements. For example, in a general-purpose video-playback device such as a set-top digital video recorder (e.g., TiVo or ReplayTV), the designer may use the buffer-level processing requirement for the video decoder, the rate-based processing requirement for background system maintenance tasks, the deadline-based processing requirement for the on-screen user-interface, the utilization processing requirement for “unidentified” tasks which may be either rare or undefined at system design time. When only one type of processing requirement is used for all different types of processing requirements, the result may be less than desirable because the processing requirements of all applications may not be effectively met.

### Computer System and Computer Readable Media

The operations of these various methods may be implemented by a processor in a computer system, which executes sequences of computer program instructions that are stored in a memory which may be considered to be a machine-readable storage media. The memory may be random access memory, read only memory, a persistent storage memory, such as mass storage device or any combination of these devices. Execution of the sequences of instruction may cause the processor to perform operations according to the process described in FIGS. 6 and 7, for example.

The instructions may be loaded into memory of the computer system from a storage device or from one or more other computer systems (e.g. a server computer system) over a network connection. The instructions may be stored concurrently in several storage devices (e.g. DRAM and a hard disk, such as virtual memory). Consequently, the execution of these instructions may be performed directly by the processor. In other cases, the instructions may not be performed directly or they may not be directly executable by the processor. Under these circumstances, the executions may be executed by causing the processor to execute an interpreter that interprets the instructions, or by causing the processor to execute a compiler which converts the received instructions to instructions that which can be directly executed by the processor. In other embodiments, hard-wired circuitry may be used in place of or in combination with software instructions to implement the present invention. Thus, the present invention is not limited to any specific combination of hardware circuitry and software, or to any particular source for the instructions executed by the computer system.

From the above description and drawings, it will be understood by those of ordinary skill in the art that the particular embodiments shown and described are for purposes of illustration only and are not intended to limit the scope of the invention. Those of ordinary skill in the art will recognize that the invention may be embodied in other specific forms without departing from its spirit or essential characteristics. For example, embodiments of the invention may be used in virtual machine environment where there may be multiple virtual machines, each processing multiple types of processing requirements. Similarly, although the scheduler 205 is illustrated as an independent entity, it may also be implemented in the OS, basic input output system (BIOS), firmware, etc. or any combinations thereof. References to details of particular embodiments are not intended to limit the scope of the claims.

What is claimed is:

1. A method comprising:
using processing requirements of two or more tasks to establish a performance profile for a system, wherein at least two tasks have different types of processing requirements, and wherein the performance profile is established to accommodate the processing requirements of the two or more tasks.

2. The method of claim 1, wherein the processing requirements include a requirement relating to a completion deadline.

3. The method of claim 1, wherein the processing requirements include a requirement relating to a required processing rate.

4. The method of claim 1, wherein the processing requirements include a requirement relating to buffering of input or output data streams.

5. The method of claim 1, wherein the performance profile includes speed of a processor in the system.

6. The method of claim 5, wherein the performance profile affects power consumed by the system.

7. The method of claim 5, wherein the speed of the processor is less than or equal to a highest possible speed of the processor.

8. The method of claim 1, wherein using the processing requirements of two or more tasks to establish the performance profile of the system comprises:
determining a desired processor speed associated with each of the processing requirements.

9. The method of claim 8, further comprising aggregating the desired processor speed associated with each of the processing requirements to form a first processor speed for the system.

10. The method of claim 9, further comprising arranging the two or more tasks to enable their processing requirements to be met when the system is set to run at a second processor speed, the second processor speed being slower than the first processor speed.

11. The method of claim 1, wherein one or more of the processing requirements is provided by the corresponding task.

12. The method of claim 11, wherein one or more of the processing requirements is specified by a source external to the corresponding task.

13. A computer readable medium having stored thereon sequences of instructions which are executable by a system, and which, when executed by the system, cause the system to perform a method, comprising:
using processing requirements of two or more tasks to establish a performance profile for a system, wherein at least two tasks have different types of processing requirements, and wherein the performance profile is established to accommodate the processing requirements of the two or more tasks.

14. The computer readable medium of claim 13, wherein the processing requirements include a requirement relating to a completion deadline.

15. The computer readable medium of claim 13, wherein the processing requirements include a requirement relating to a required processing rate.

16. The computer readable medium of claim 13, wherein the processing requirements include a requirement relating to buffering of input or output data streams.

17. The computer readable medium of claim 13, wherein the performance profile includes speed of a processor in the system.

18. The computer readable medium of claim 17, wherein the performance profile affects power consumed by the system.

19. The computer readable medium of claim 17, wherein the speed of the processor is less than or equal to a highest possible speed of the processor.

20. The computer readable medium of claim 13, wherein using the processing requirements of two or more tasks to establish the performance profile of the system comprises:
determining a desired processor speed associated with each of the processing requirements.

21. The computer readable medium of claim 20, further comprising aggregating the desired processor speed associated with each of the processing requirements to form a first processor speed for the system.

22. The computer readable medium of claim 21, further comprising arranging the two or more tasks to enable their processing requirements to be met when the system is set to run at a second processor speed, the second processor speed being slower than the first processor speed.

23. The computer readable medium of claim 13, wherein one or more of the processing requirements is provided by the corresponding task.

24. The computer readable medium of claim 23, wherein one or more of the processing requirements is specified by a source external to the corresponding task.

25. A system, comprising:
a processor; and
a scheduler coupled to the processor, the scheduler is to establish a performance profile to process two or more different types of processing requirements of two or more tasks, the performance profile including a processor speed for the processor

26. The system of claim 25, wherein the two or more different types of processing requirements include a time-critical processing requirement and a non-time-critical processing requirement.

27. The system of claim 25, wherein the scheduler is to combine the different types of processing requirements into one processing requirement.

28. The system of claim 27, wherein the scheduler is to combine the different types of processing requirements into one processing requirement by determining a processor speed associated with each of the different types of processing requirements.

29. The system of claim 28, wherein the scheduler is to form an aggregate processor speed using the processor speed associated with each of the different types of processing requirements.

30. A method, comprising:
receiving a first processing requirement of a first application and a second processing requirement of a second application, wherein the processing requirement of the first application is different from the processing requirement of the second application;
forming a third processing requirement using the first processing requirement and the second processing requirement; and
establishing a performance profile using the third processing requirement.

31. The method of claim 30, wherein the first processing requirement is specified by the first application.

32. The method of claim 30, wherein the first processing requirement is specified by a source external to the first application.

33. The method of claim 30, wherein said establishing the performance profile using the third processing requirement includes determining a first processor speed associated with the first processing requirement and a second processor speed associated with the second processing requirement.

34. The method of claim 33, wherein said establishing the performance profile using the third processing requirement further includes aggregating the first processor speed and the second processor speed to form a third processor speed.

35. The method of claim 34, further comprising:
processing the first application and the second application with the processor set to run at the third processor speed.

36. The method of claim 35, wherein the third processor speed is to enable processing the first application and the second application with less processor idle time comparing to a speed faster than the third processor speed.

37. A system, comprising:
a processor; and
a voltage scheduler coupled to the processor, the voltage scheduler is to receive at least one time-critical processing requirement and at least one non-time-critical processing requirement, wherein the voltage scheduler is to determine a processor speed for the processor to accommodate the time-critical processing requirement and the non-time-critical processing requirement.

38. The system of claim 37, wherein the processor speed is less than a highest possible processor speed of the processor.

39. The system of claim 37, wherein the time-critical processing requirement is associated with a first task and the non-time-critical processing requirement is associated with a second task.

40. The system of claim 37, wherein the voltage scheduler is to determine the processor speed for the processor by blending the time-critical processing requirement and the non-time-critical processing requirement.

41. The system of claim 40, wherein the voltage scheduler blends the time-critical processing requirement and the non-time-critical processing requirement by determining a processor speed for the time-critical processing requirement and a processor speed for the non-time-critical processing requirement.

42. The system of claim 41, wherein the voltage scheduler is to aggregate the processor speed for the time-critical processing requirement with the processor speed for the non-time-critical processing requirement to form the processor speed for the processor.

43. The system of claim 42, wherein the processor speed for the processor is to accommodate the time-critical processing requirement and the non-time-critical processing requirement at lower power consumption comparing to a faster processor speed.
